(19) United States
(12) Patent Application Publication
(10) Pub. No.: US 2010/0218141 A1
(43) Pub. Date: Aug. 26, 2010

(54) VIRTUAL SPHERE INPUT CONTROLLER FOR ELECTRONICS DEVICE

(75) Inventors: SHUANG XU, Algonquin, IL (US); Changxue Ma, Barrington, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 12/390,682

(22) Filed: Feb. 23, 2009

(51) Int. Cl. G06F 3/048

(52) U.S. Cl. 715/834; 715/847

(57) ABSTRACT

An electronic device including a processor communicably coupled to a display component wherein the processor is configured to generate and display an interactive icon on the display component. The interactive icon includes a primary item and at least one alternative item, and the processor is configured to visually prioritize the presentation of the primary item on the display component relative to the presentation of the alternative item.

### FIELD OF THE DISCLOSURE

The present disclosure relates generally to portable electronic devices, for example wireless communication handsets and other handheld devices, and corresponding methods.

### BACKGROUND

Hierarchical menus are used pervasively to provide large amounts of command choices in computing system user interfaces. In some implementations, the command choices are located within a system of nested menus. Several usability issues have been encountered however when adapting hierarchical menus to interfaces on relatively small electronic devices. For example, the small display size limits the number of menu options that may be displayed at a particular time. Also, there is limited space to display command labels and the visibility of nested input options. Moreover, additional navigation key maneuvering is often required to locate a target menu on small electronic devices.

Some solutions have been proposed to reduce the navigation and menu-traversing effort on handheld electronic devices. For example, some devices made by BLACKBERRY utilize a trackball to control the movement of the cursor on a small screen to facilitate navigation of hierarchical menus. The APPLE iPod-wheel and the Omega-wheel on the MOTOROLA ROKR E8 cell phone also facilitate and make list-scrolling of hierarchical menus easier in handheld devices. However, these interaction techniques do not change hierarchical menu structures, which require sequential traversing from current menu options to the target menu options.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is a schematic block diagram of an electronic device.

FIG. 2 illustrates an electronic device displaying icons.

FIG. 3 illustrates another electronic device displaying icons.

FIG. 4 illustrates a sequence of display screens.

### DETAILED DESCRIPTION

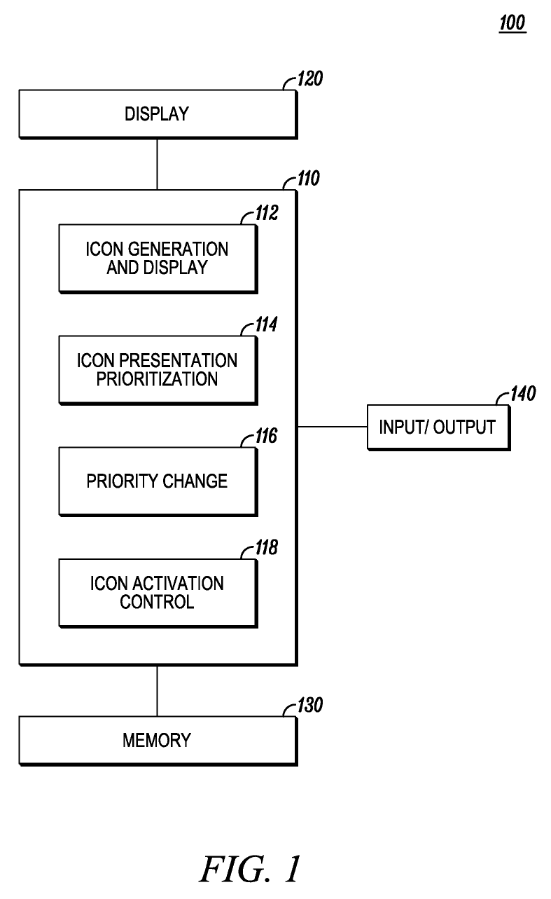

FIG. 1 illustrates an electronic device 100 comprising a processor 110 communicably coupled to a display component 120. The exemplary processor is a digital processor that executes software or firmware stored in a memory device 130, which may be embodied as RAM, ROM or other memory devices or a combination thereof. Thus configured, the electronic device may run various applications upon the execution of application code stored in memory by the processor. In some instantiations, one or more applications may run on an operating system or other lower level program running on the electronic device. Such applications, operating systems and other programs may be proprietary, or not, and are generally well known to those having ordinary skill in the art.

In one embodiment, the electronic device is implemented as a handheld device like a cell phone, or a smart phone, or a personal digital assistant, or a handheld electronic game or some other handheld device. The electronic device may also be implemented as a laptop or notebook computer or alternatively as a desktop computer or as a video gaming station or other work station. More generally, the electronic device may be implemented as any consumer or industrial device that includes a user interface having a display component. Such an electronic device may be integrated with a durable consumer appliance like a refrigerator, washing machine, dishwasher range. In other embodiments, the electronic device is integrated with an industrial appliance or machine. The electronic device may also be integrated with a vehicle, like a car or bus or aeroplane or watercraft. Exemplary display components include but are not limited to cathode ray tubes (CRTs) and flat panel displays among other display devices implemented using currently known or future display technologies.

In FIG. 1, the electronic device 100 includes user inputs and outputs 140, the particular form of which may depend on the particular implementation of the electronic device. The user inputs may be embodied as a keyboard, or keypad, or trackball, touchpad, or microphone, or any other input device. In some embodiments, the user input is integrated with the display component in the form of a touch screen. The user input may also be embodied as a combination of these and other user inputs. The user output may be embodied as an audio output among other known outputs. The electronic device may also include a wireless transceiver that interfaces with user inputs and outputs like a Bluetooth enabled headset. Such a transceiver may be embodied as a Bluetooth device or other relatively near space transceiver that communicates wirelessly with a remote device.

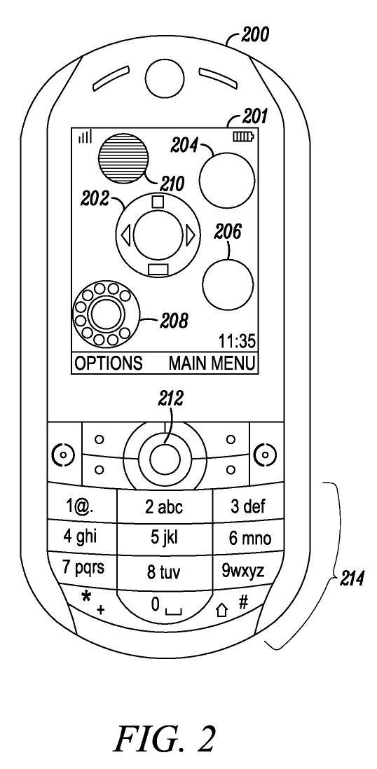

In FIG. 2, the exemplary electronic device includes a user interface for making selections and entering data. The user interface includes an input device 212, which may be embodied as a trackball or joystick or some other input for selecting items displayed on the display either directly or using a curser. In other embodiments, the input device may be an accessory, for example a mouse or other input device coupled to the electronic device. The electronic device also includes an integrated keypad 214 for inputting numbers, text and symbols. Some devices also include dedicated and/or software configurable keys for inputting data and making selections. In alternative embodiments, the keypad may be implemented at least in part as a touch screen. Such data input and item selection user interfaces are known generally by those having ordinary skill in the art and are not discussed further herein. The exemplary user interface is not intended to limit the disclosure as most any known or future input device and keypads may be suitable for use in these and other instantiations of the present disclosure.

According to one aspect of the disclosure, multiple application icons are simultaneously displayed on the display component. In one implementation, generally, each application icon is associated with a corresponding application on the electronic device. Alternatively, each icon could be associated with a corresponding feature or function or command element of a particular application or other hardware apparatus. Selection of an icon may launch or start a corresponding application or other feature or function or command associated with the icon. Such a selection may be performed, for example, by clicking or double clicking on the icon or via some other input, for example, a voice command, to the electronic device. The icon may also be used to open a properties window associated with an application or feature or function. In FIG. 1, the processor includes icon generation and display functionality 112 to enable these aspects of the disclosure.

In one embodiment, generally, the processor is configured to visually prioritize the presentation of the multiple application icons displayed on the display component. In one embodiment, the presentation priority of the icons is dictated expressly by the user. In other embodiments, the presentation priority of the icons is based on one or more other criterion, some non-limiting examples of which are discussed further below. In FIG. 1, the processor includes icon presentation prioritization functionality 114 that operates to prioritize the presentation of the icons on the display. In some embodiments, the presentation priority of the icons changes. In some instances for example the user may swap a more highly prioritized icon with one that is less highly prioritized, for example, by dragging and dropping a lowly prioritized icon on a highly prioritized icon or vice-versa. In some embodiments where there are multiple selectable items associated with an interactive icon, the user is generally able to change the location of the items on the icon. In other instances other mechanisms control the changing presentation priority of the icons.

In FIG. 1, the processor includes icon presentation priority changing functionality 116 that enables reconfiguration of the icon presentation priority. These functions are controlled in the exemplary embodiment by software or firmware or other code stored in memory and executed the processor.

In a more particular implementation, the processor is configured to visually prioritize the multiple icons by presenting at least some of the icons on the display component in different sizes. For example, FIG. 2 illustrates a cellular telephone handset 200 having a multimedia playback icon 202 and several other icons 204, 206, 208 and 210 on the display component 201. These other icons may be associated with other applications such as a browser or a text messaging application or some other application. Alternatively, the icons may be associated with some function performed by the electronic device rather than an application. In one mode of operation, the processor is configured to display higher priority icons in a size that is larger than a size of lower priority icons. More generally, the size of an icon may be proportionate or inversely proportionate to the priority of the application or function or feature or command associated with the icon. In FIG. 2 for example the multimedia icon 202 is larger than the other icons.

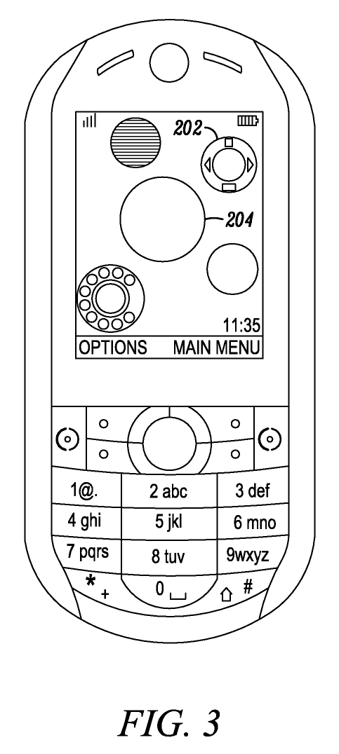

In some embodiments, generally, the user may swap the position of icons on the display component to change the presentation prioritization. In FIG. 3, for example, the positions of the multimedia icon 202 and the icon 204 are changed. The icon 204 is move to the central portion of the display such that the icon 204 becomes a more highly prioritized icon and hence the icon also having the largest size in FIG. 3. The swap may be performed using a drag-and-drop operation or by other means.

In another more particular implementation, the processor is configured to visually prioritize the presentation of the multiple icons by presenting at least some of the application icons in different locations on the display component. In a particular implementation, higher priority icons are located nearer a central portion of the display component and lower priority icons are located farther from the central portion of the display component. In FIG. 2 for example the multimedia icon 202 is centrally located on the display. More generally, the distance of the icon relative to the central portion of the display may be proportionate or inversely proportionate to the priority of application or feature or function associated with the icon. FIG. 2 also illustrates the prioritization of an icon based on a combination of the location and the size of the icon.

In yet another more particular implementation, the processor is configured to visually prioritize the presentation of the multiple icons by presenting at least some of the application icons with different brightness levels on the display component. The brightness of an icon may be implemented by highlighting the icon. Thus an icon having an increased brightness may be referred to as a highlighted icon. In one implementation, higher priority icons are displayed more brightly than lower priority icons. In other embodiments, the opposite it true. The icon brightness may be used in combination with the location and size of the icon to indicate priority.

In other embodiments, other features of characteristics of the multiple icons may be used to prioritize the presentation of the icons on the display component. Such features include, but are not limited to, icon color or a perturbation characteristic of the icon.

In one implementation, the processor is configured to prioritize the presentation of the multiple application icons based on the last use of a corresponding application or function or feature associated with the multiple icons. According to this embodiment, a most recently used icon has an opposite priority than a least recently used icon. For example, a most recently used icon may be given a highest priority, at least for implementations where higher priority is associated with more recent use. Alternatively, the most recently used icon may be given a lowest priority, at least for implementations where lower priority is associated with less recent use. In FIG. 2 for example the highly prioritized multimedia icon 202 may correspond to the most recently used application. The recent use of an application may thus also serve as the basis for changing the presentation priority of one or more icons.

In another implementation, the processor is configured to prioritize the presentation of the multiple application icons based on a frequency of use of a corresponding application or function or feature associated with the icons. According to this embodiment, a most frequently used icon has an opposite priority than a least frequently used icon. For example, a most frequently used icon may be given a highest priority, at least for implementations where higher priority is associated with more frequent use. Alternatively, the most frequently used icon may be given a lowest priority, at least for implementations where lower priority is associated with less frequent use. The frequency of use of an application may thus also serve as the basis for changing the presentation priority of one or more icons.

In other embodiments, the processor is configured to visually prioritize the presentation of the multiple application icons based on contextual information. More particularly, the icons that are displayed most prominently may correspond to an application or feature or function that is most relevant to some contextual variable. In one embodiment, the prioritization of the icon presentation is based on a location of the electronic device. For example, if the electronic device is in an office environment, an email application may be presented most prominently on the display component. Other icons may be displayed prominently when the electronic device is in other locations. In meeting or theater, for example, a profile change icon could be displayed prominently if current profile, e.g., an alert profile, is not consistent with the location. A changing context may thus serve as the basis for changing the presentation priority of an icon.

In another contextual embodiment, the prioritization of the icon presentation may be based on the some indicia indicative of the activity of the user of the electronic device. For example, such activity may be whether the user is sleeping or driving or walking or exercising. In other embodiments, a mobile device equipped with GPS and accelerometer sensors are capable of detecting of human activities such as walking, sleeping or driving. For example, in sleeping, the devices will be prepared for features such as weather reports or task list. When driving, a frequently dialed list would be displayed prominently. A change in the activity of the user may thus serve as the basis for changing the presentation priority of an icon.

In some implementations, one of the icons is active and the one or more other icons are not active, such that inputs at the user interface control or affect only the active icon and not the inactive icons. In other embodiments, multiple icons are active simultaneously. Whether an icon is active or not may be controlled explicitly by the user or it may be based on some other criterion. In some embodiments, for example, the only active icon may be the icon having the highest presentation priority. In other embodiments however the presentation priority is not determinative of whether an icon is active. Whether an icon is active may also depend on whether the application or function associated with the icon has been launched or is running. In implementations where there is only a single active icon at any particular time, the active icon can be swapped with an inactive icon such that the inactive icon becomes active and the active icon becomes inactive. In FIG. 1, the processor includes icon activation control functionality 118 that enables activation of the one or more icons.

In one embodiment, the processor is configured to generate and display an interactive icon on the display component wherein the interactive icon includes multiple user selectable items. The selectable items may be functional or data inputs or some other user selectable item. The selectable items may be associated with an application executable or running on the electronic device. In some embodiments, a user can change the default setting of items or commands associated with an application by specifying which commands should be disposed on the icon. The user may also dictate how many commands to be included and the location and order of these commands disposed along the perimeter of the icon.

In a more particular implementation, the interactive icon is a virtual spherical icon displayed as a two-dimensional image on the display component. In one implementation, the processor is configured to visually prioritize the presentation of a primary selectable item by making the primary selectable item appear to be closer to a user of the device than alternative selectable items. In the spherical icon example, the processor is configured to locate the primary selectable item toward a central portion of the spherical icon and to locate the secondary selectable items towards a periphery of the spherical icon wherein the primary selectable item appears to be more near the user and the secondary selectable items.

In some embodiments, the processor is also configured to enable the user to select items on the interactive icon using an input device of the electronic device. In some embodiments, selection of an item on the interactive icon causes the processor to execute or perform some function associated with the selected item. In another embodiment, selection of an alternative item on the icon will cause the selected alternative item to become the primary item. According to this alternative, the processor swaps the status of the primary item and the status of the selected alternative item. For example, a single click on an item located toward the perimeter of the interactive icon may cause the selected item to swap locations with the item located toward the central portion of the interactive icon. Alternatively, selecting the alternative item may cause the selected item to swap characteristics, e.g., size, highlight, font, etc., associated with the primary item. Alternatively, an item located near the perimeter of the interactive icon may be made the primary item by dragging it toward the central portion of the icon wherein the item previously located toward the center of the icon is moved to the periphery of the icon.

In embodiments where only one command element is differentiated, e.g., highlighted, at any given time, the processor may be configured so that selection of the interactive icon generally causes the processor to perform the function associated with the primary item. In this embodiment, where a single click causes an alternative item to become the primary item, selection of the interactive icon may be performed by double-clicking the interactive icon. In embodiments where the priority of the items is changed by dragging the items about the interactive icon, the processor may be configured so that selection, by a single click, of the interactive icon generally causes the processor to perform the function associated with the primary item.

In FIG. 2, a virtual spherical icon 202 is associated with an audio or video playback application displayed as a two-dimensional image on the display component 201. In other embodiment, the virtual spherical icon and the one or more functional inputs or command elements thereof may be associated with other applications. The icon includes command elements typical of a multimedia application including a PLAY, REVERSE, FORWARD, STOP and PAUSE functional inputs. In FIG. 2, the PLAY function is the primary input wherein selection of the icon will invoke the PLAY function of the associated application. The user may select the functional inputs using an input device, for example, a joystick 212, of the electronic device. The user may change the primary function of the icon by selecting one of the secondary commands located toward the periphery of the icon. In one implementation, selection of the PLAY function causes the PLAY function to become the primary input, thereby indicating that the application is in PLAY mode. Similarly, selection of the PAUSE function causes the PAUSE function to become the primary functional input thereby indicating that the application is in the PAUSE mode. In other implementations, selection of an input or item on the virtual spherical icon does not result in the selected item becoming the primary item.

In other embodiments, the interactive icon may be associated with another application and other command elements may be included on the icon. For example, a navigation application may include North, South, East and West commands near the perimeter of the interactive icon and another command located in the central portion thereof. In other embodiments, the interactive icon is associated with an interactive game. In FIG. 2, five command elements are shown in the interactive icon, but in other embodiments the icon may include a greater or a fewer number of items.

In one particular implementation, the processor is configured to execute a speech recognition application that converts speech to text. In some instances, it is desirable for the speech recognition application to offer more than one possible word or phrase for a particular word or segment of detected speech input. Such instances arise for example, where the speech recognition application does not recognize speech input or where the word detected by the speech recognition application may be spelled differently. Some such words are in a class known linguistically as homophones. According to one embodiment, primary and alternative text candidates based on recognized speech are displayed on the interactive icon. In some embodiments, the presentation of the primary and alternative text candidates may be prioritized as discussed above. For example, the primary text candidate may be enlarged or centrally located or highlighted to emphasize or prioritize it relative to the alternative text candidates.

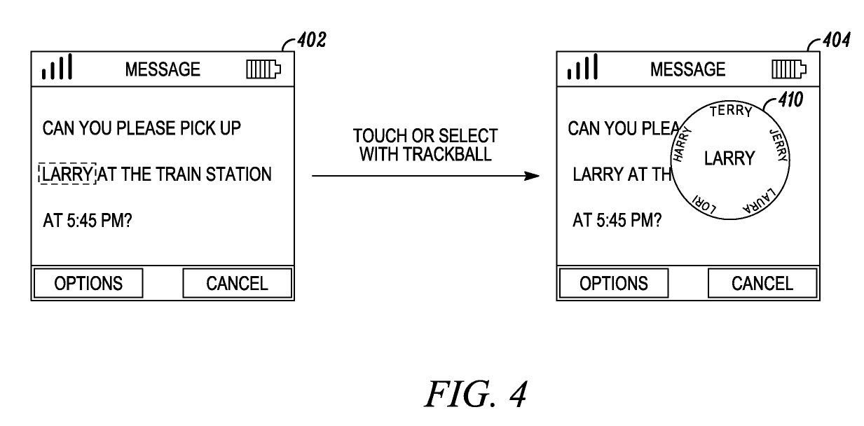

FIG. 4 illustrates a sequence of screens displayed on an electronic device executing a speech to text application. Initially, the application displays a string of words derived from speech detected and input to the application as indicated on the screen 402, which is produced on the display component. The word “Larry” appears delineated from other displayed words or text. The text may be delineated by highlighting or by bolding or coloring the text or by using a different font type or using some other visual variation relative to the other words or text on the display. In this embodiment, the highlight indicates that the word “Larry” is a primary candidate and that there is at least one alternative candidate. In one embodiment, the one or more alternative data items are one of the N-Best candidates that have recognition confidence scores similar to the score of the selected text or word.

By selecting the delineated text, in this example the word “Larry”, an interactive icon is subsequently displayed on the screen produced on the display component of the electronic device. In other embodiments, the interactive icon is displayed automatically upon recognition by the system that one or more possible alternatives exist. In FIG. 4, screen 404 is displayed on the display component after selecting the highlighted text. The screen 404 includes an interactive icon 410 with the primary text candidate and several alternative text candidates. In this example, the primary text or word candidate “Larry” is prioritized using a combination of prioritizing characteristics. Particularly, the primary candidate is located in the central portion of the icon and it has a relatively large and bold font relative to the alternative word candidates. In FIG. 4, the alternative candidates are located near a periphery of the interactive icon. At least one alternative candidate, “Terry”, has a bold font, which may be used to prioritize it relative to other alternatives. The alternatives may also be prioritized relative to one another based on font size wherein the font size is proportionate to the likelihood that the word is preferred. The user may select the desired word using the user interface. In one implementation, the interactive icon is a virtual spherical icon. In other implementations however the interactive icon has some other form or appearance.

In another particular implementation, the processor is configured to execute a text entry application that accepts text input at the user interface of the electronic device. The text entry application may be embodied as a word processor, a text messaging application, an instant messaging application or some other application that accepts text input. In one embodiment associated with a text entry application, a prediction algorithm predicts words or phrases based on the input of a portion of text or a word or a portion of a phrase. According to this implementation, the processor is configured to generate and display an interactive icon in response to predicting a word based on text input, wherein primary and alternative prediction candidates are displayed on the interactive icon at the user interface of the electronic device. In one implementation, the interactive icon with the predication candidates is displayed automatically upon the user partially entering the complete word or phrase. Alternatively, the display of the interactive icon may be manually prompted by the user rather than be provided automatically by the application.

In some embodiments, the presentation of the primary and alternative prediction candidates may be prioritized as discussed above. For example, the primary prediction candidate may be enlarged or located centrally or highlighted to emphasize or prioritize it relative to the alternative prediction candidates on the interactive icon. According to the text predicting embodiment, the processor is configured to permit the user to select the primary correction or one of the alternative corrections provided on the interactive icon without completing the input of the word. Alternatively, the user may complete the entry of the word at the user interface.

In another embodiment associated with the text entry application, a spelling correction algorithm corrects text based on the input incorrectly spelled text. According to this implementation, the processor is configured to generate and display an interactive icon in response to incorrectly spelled text, wherein primary and alternative correction candidates are displayed on the interactive icon based on partial input at the user interface of the electronic device. In some embodiments, the presentation of the primary and alternative correction candidates may be prioritized as discussed above. For example, the primary correction candidate may be enlarged or centrally located or highlighted to emphasize or prioritize it relative to the one or more alternative correction candidates on the interactive icon. The processor is configured to permit the user to select the one of the correction candidates. Alternatively, the user may continue to input text to complete the spelling of the word.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. An electronic device comprising:
a display component;
a processor communicably coupled to the display component;
multiple application icons simultaneously displayed on the display component, each application icon associated with a corresponding application on the electronic device,
the processor configured to visually prioritize the presentation of the multiple application icons displayed on the display component.

2. The device of claim 1,
each of the multiple application icons is a virtual spherical application icon displayed as a two-dimensional image on the display component,
the processor configured to prioritize the presentation of the multiple application icons on the display component so that some application icons are larger and other application icons appear smaller, the larger application icons appear to be more near and smaller application icons to appear more distant.

3. The device of claim 2, the processor configured to present the larger application icons toward a central portion of the display component and the smaller application icons toward a peripheral part of the display component.

4. The device of claim 2, one of the application icons is highlighted and larger than the other application icons.

5. The device of claim 4, the processor is configured to cause an application icon to become highlighted and larger than other application icons in response to selection of the icon using an input of the electronic device, wherein a previously highlighted and larger icon is reduced in size and de-highlighted upon selection of another application icon.

6. The device of claim 1, the processor configured to visually prioritize the presentation of the multiple application icons by presenting at least some of the application icons on the display component in different sizes, wherein higher priority icons are larger than lower priority icons.

7. The device of claim 1, the processor configured to visually prioritize the presentation of the multiple application icons by presenting at least some of the application icons in different locations on the display component, wherein higher priority application icons are located nearer a central portion of the display component and lower priority application icons are located nearer a perimeter of the display component.

8. The device of claim 1, the processor configured to visually prioritize the presentation of the multiple application icons based on a most recent use of a corresponding application associated with the multiple icons wherein an application icon corresponding to a most recently used application has an opposite priority than an application icon corresponding to a least recently used application.

9. The device of claim 1, the processor configured to visually prioritize the presentation of the multiple application icons based on a frequency of use of corresponding applications associated with the application icons.

10. The device of claim 1, the processor configured to visually prioritize the presentation of the multiple application icons based on contextual information obtained by the electronic device.

11. An electronic device comprising:
a display component;
a processor communicably coupled to the display component;
the processor configured to generate and display an interactive icon on the display component,
the interactive icon having a user selectable primary item and at least one user selectable alternative item,
the processor configured to visually prioritize the presentation of the primary item on the display component relative to the presentation of the alternative item.

12. The device of claim 11, the processor configured to visually prioritize the presentation of the primary item by locating the primary item in a central portion of the interactive icon and locating a plurality of user selectable alternative items toward a periphery of the interactive icon.

13. The device of claim 11,
the interactive icon is a virtual spherical icon displayed as a two-dimensional image on the display component,
the processor configured to visually prioritize the presentation of the primary item by making the primary item appear to be closer to a user of the device than the alternative item.

14. The device of claim 11,
the processor configured to execute a text prediction application that accepts text input,
the processor configured to generate and display the interactive icon in response to predicting a word based on text input,
the primary item represents a primary text candidate based on the text input and the alternative item represents an alternative text candidate based on the text input.

15. The device of claim 11,
the processor configured to execute a spell checking application on text input the electronic device,
the processor configured to generate and display the interactive icon in response to detecting incorrectly spelled text,
the primary item represents a primary correction candidate and the alternative item represents an alternative correction candidate.

16. The device of claim 11,
the application executed by the processor supports speech to text input,
the processor configured to generate and display the interactive icon on the display component,
the primary item is text predicted to correspond to the recognized speech input and the alternative item is alternative text predicted to correspond to the recognized speech input.

17. An electronic device comprising:
a display component;
a processor communicably coupled to the display component;
a virtual spherical icon displayed on the display component as a two-dimensional image representation generated by the processor,
the virtual spherical icon associated with an application on the electronic device,
the virtual spherical icon having a plurality of command elements disposed on the two-dimensional image representation of the virtual spherical icon,
one command element disposed in a central portion of the two-dimensional image representation of the virtual spherical icon and at least one other command element disposed toward a perimeter of the two-dimensional image representation of the virtual spherical icon.

18. The device of claim 17, the virtual spherical icon having a plurality of command elements disposed toward the perimeter of the two-dimensional image representation of the virtual spherical icon.

19. The device of claim 17, the virtual spherical icon is a media icon associated with a media application executable by the electronic device, the command elements are associated with the media application.

20. The device of claim 17, the processor configured to virtually rotate the virtual spherical icon upon selection of a command element located toward the perimeter of the virtual spherical icon is moved toward the central portion of the virtual spherical icon.

21. The device of claim 17, the processor configured to virtually rotate the virtual spherical icon so that a next most likely to-be-selected command element is disposed in the central portion of the virtual spherical icon while the user is not interacting with the application.
